(19) United States
(12) Patent Application Publication
(10) Pub. No.: US 2007/0073513 A1
(43) Pub. Date: Mar. 29, 2007

(54) Determining RFID tag location

(76) Inventor: Joshua Posamentier, Oakland, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/239,715

(22) Filed: Sep. 29, 2005

(51) Int. Cl. G01C 17/00; G01C 19/00; G01C 9/00; G06F 15/00

(52) U.S. Cl. 702/150

(57) ABSTRACT

In some embodiments, a radio frequency identification (RFID) reader with multiple antennas may determine the location of an RFID tag relative to the reader's antennas, by using a difference-in-time-of-arrival technique to triangulate on the RFID tag based on the difference in distances between the tag and each antenna. A given point in the signal from the RFID tag may provide a narrow point in time from which to make the calculations, while a common clock to the multiple receive paths may permit making accurate measurements of the difference in time of reception of that point at the different antennas. In some embodiments, movement of the RFID tag may be determined by calculating a series of locations over time.

### BACKGROUND

Using radio signals to accurately determine the physical location of an object with a radio frequency identification (RFID) tag attached to it may be desirable in many types of situations. Techniques that use triangulation of received radio signals are sometimes attractive for determination of physical location. Some such techniques may make use of external devices (e.g., a Global Positioning System receiver may make use of orbiting satellites). Other techniques may make use of circuitry to synchronize the tag's clock with a clock on another device for precise time-of-transit calculations. While these techniques can be justified for many applications, they require complex and expensive circuitry at the object, something that cannot be justified for a low cost device such as an RFID tag.

### BRIEF DESCRIPTION OF THE DRAWINGS

Some embodiments of the invention may be understood by referring to the following description and accompanying drawings that are used to illustrate embodiments of the invention. In the drawings:

FIG. 1 shows a diagram of a system to determine a location of an object with an attached RFID tag, according to an embodiment of the invention.

FIG. 2 shows a system for determining a location of an RFID tag, according to an embodiment of the invention.

FIG. 3 shows a flow diagram of a method of determining the relative location of an RFID tag, according to an embodiment of the invention.

### DETAILED DESCRIPTION

In the following description, numerous specific details are set forth. However, it is understood that embodiments of the invention may be practiced without these specific details. In other instances, well-known circuits, structures and techniques have not been shown in detail in order not to obscure an understanding of this description.

References to “one embodiment”, “an embodiment”, “example embodiment”, “various embodiments”, etc., indicate that the embodiment(s) of the invention so described may include particular features, structures, or characteristics, but not every embodiment necessarily includes the particular features, structures, or characteristics. Further, some embodiments may have some, all, or none of the features described for other embodiments.

In the following description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements co-operate or interact with each other, but they may or may not be in direct physical or electrical contact.

The term “processor” may refer to any device or portion of a device that processes electronic data from registers and/or memory to transform that electronic data into other electronic data that may be stored in registers and/or memory. A “computing platform” may comprise one or more processors.

Within the context of this document, an RFID tag may be defined as comprising an RFID antenna (to receive an incoming signal that serves to query the RFID tag and to transmit a response in the form of a modulated radio frequency signal), and an RFID tag circuit (which may include circuitry to store an identification code for the RFID tag, circuitry to modulate a signal transmitted through the antenna, and in some embodiments a power circuit to collect received energy from the incoming radio frequency signal and use that energy to power the operations of the RFID tag circuit). As is known in the field of RFID technology, “transmitting” a signal from an RFID tag may include either: 1) providing sufficient power to the antenna to generate a signal that radiates out from the antenna, or 2) reflecting a modulated version of the received signal.

As used herein, unless otherwise specified the use of the ordinal adjectives “first”, “second”, “third”, etc., to describe a common object, merely indicate that different instances of like objects are being referred to, and are not intended to imply that the objects so described must be in a given sequence, either temporally, spatially, in ranking, or in any other manner.

Various embodiments of the invention may be implemented in one or any combination of hardware, firmware, and software. The invention may also be implemented as instructions contained in or on a machine-readable medium, which may be read and executed by one or more processors to perform the operations described herein. A machine-readable medium may include any mechanism for storing, transmitting, and/or receiving information in a form readable by a machine (e.g., a computer). For example, a machine-readable medium may include a storage medium, such as but not limited to read only memory (ROM); random access memory (RAM); magnetic disk storage media; optical storage media; flash memory devices. A machine-readable medium may also include a tangible medium through which electrical, optical, acoustical or other form of propagated signals representing the instructions may pass, such as antennas, optical fibers, communications interfaces, and others.

Various embodiments of the invention may pertain to determining a location of a radio frequency identification (RFID) tag by receiving a transmission from the RFID tag through multiple antennas and receive chains, using the difference in reception times to determine the relative difference in distance between the tag and the respective antennae, and triangulating those differences to calculate the relative location of the RFID tag with respect to a known reference point. In some embodiments the antennas and receive chains are part of an RFID reader.

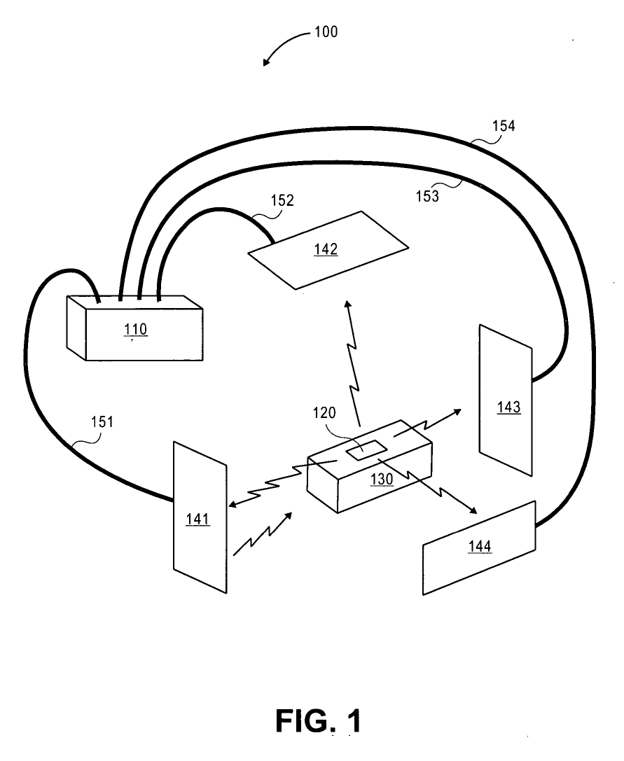

FIG. 1 shows a diagram of a system to determine a location of an object with an attached RFID tag, according to an embodiment of the invention. For ease of illustration, various items in the figure are shown with rectangular shapes, but different embodiments of the invention may not be limited to the particular shapes that are shown. System 100 shows RFID reader 110 that may transmit and/or receive through one or more of antennas 141, 142, 143, or 144, which are shown connected to it through coaxial cables 151, 152, 153, and 154, respectively. In some embodiments the coaxial cables are all of the same length so that the signal transit time through each cable will be the same, although other embodiments may use different techniques. The example shows directional patch antennas with a planar shape, although other embodiments may use other antenna shapes. In some embodiments, the antennas may be substantially directional, i.e., they may transmit (or receive) relatively strongly in some directions but relatively weakly in other directions. For example, the planar antennas shown in FIG. 1 may transmit a comparatively strong signal (or be able to receive a comparatively weak signal) in a direction orthogonal to the plane of the antenna on one side, but may transmit the same signal comparatively weakly (or not be able to receive a weak signal) in a direction coplanar to the face of the antenna or behind it.

RFID reader 110 may transmit an enabling signal through any of antennas 141, 142, 143, 144, for the purpose of eliciting a response from an RFID tag 120 located within operating range of the various antennas. The example of FIG. 1 shows four antennas arranged in approximately orthogonal directions from an area in which RFID tags are expected to be located, although other embodiments may use other antenna placements and other quantities of antennas. FIG. 1 also shows an RFID tag 120 attached to an object 130. By determining the presence and location of the RFID tag 120, the system may determine the presence and location of object 130.

When RFID tag 120 is enabled by a proper signal from RFID reader 110, RFID tag 120 may respond by transmitting a signal containing an identification number for the RFID tag 120. The illustrated example shows the enabling signal being transmitted by antenna 141. In some embodiments the enabling signal may be transmitted from a separate antenna (not shown) that is not used for receiving the response from the RFID tag 120. In other embodiments the enabling signal may be transmitted from one of the antennas that are also used for receiving the response from the RFID tag 120. In some embodiments the same antenna will always be used for this transmission, but in other embodiments the system may select one of the available antennas, based on various criteria (for example, each antenna may be tested to see which transmitting antenna elicits the strongest and/or least distorted response from the RFID tag 120).

The RFID tag 120 may respond to a properly enabling signal by transmitting a response that may be received by the antennas. Various types of signals may be considered to be properly enabling, depending on the particular RFID technology being used. In some embodiments the response signal may be somewhat omnidirectional (that is, it may be strong enough in all directions to be picked up by each of the receiving antennas, regardless of the orientation of the RFID tag with respect to the receiving antennas, but other embodiments may use other techniques. In some embodiments, the relative signal strength of the signal as received at each antenna (compared to the signal strength at the other antennas) may not matter, as long as the signal at each antenna is strong enough to be accurately received.

When a signal is transmitted from RFID tag 120, the relative time at which a given point in that signal is received by each antenna may be slightly different, based on the different transit times for the signal to reach each of the respective antennas. The different transit times, in turn, may be based on the difference in distance between the RFID tag and the respective antennas. The different times of reception, therefore, may be used to calculate the relative difference in the distance between the RFID tag and each receiving antenna. Using triangulation techniques, this difference in distance may be used to calculate the location of the RFID tag relative to the locations of the various receiving antennas, provided the relative distance and relative direction of each antenna from the other antennas is known,

In the antenna configuration shown in FIG. 1, the antennas 141, 142, 143, 144 are shown in a substantially non-coplanar configuration, i.e., any one of the four antennas is not located on a plane substantially defined by the other three antennas. Note: The terms ‘planar’, ‘co-planar’, ‘line’, and ‘point’ may be used somewhat loosely in this document, since each may be theoretically defined by infinitely small points, while each piece of equipment used is much larger than a point and doesn't have the accuracy of the theoretical calculations. Further, other errors of measurement may contribute to uncertainty and/or inaccuracy in determining a well-defined plane, line, or point. However, the conceptual ideas of planes, lines, and points are still useful here, and an error of margin for each can be determined based on the finite size of the antennas and other contributing sources of error. Hence, the term ‘substantial’, and its derivatives, may be used to describe how the theoretical concepts are being applied to real-world dimensions and configurations, with their inherent levels of uncertainty and/or inaccuracy.

Using techniques based on comparing the difference in distances (not the actual distances) from known reference points, RFID tag 120 may be located substantially within a plane by using the two antennas 141, 143, located substantially within a line on that plane by using three antennas 141, 142, 143, and located substantially at a point on that line by using four antennas 141, 142, 143, and 144. Thus the four antennas may be used to substantially locate the tag to a point within 3-dimensional space, relative to the four antennas. While this is the configuration shown in FIG. 1, other embodiments may use three or even two antennas to substantially locate an RFID tag to a line or plane, respectively, if this is sufficient for the application being served. Conversely, more than four antennas may be used if the location needs to be known with greater accuracy, as the added information may be used to reduce some of the inaccuracy caused by such things as large antenna size, timing variations, etc.

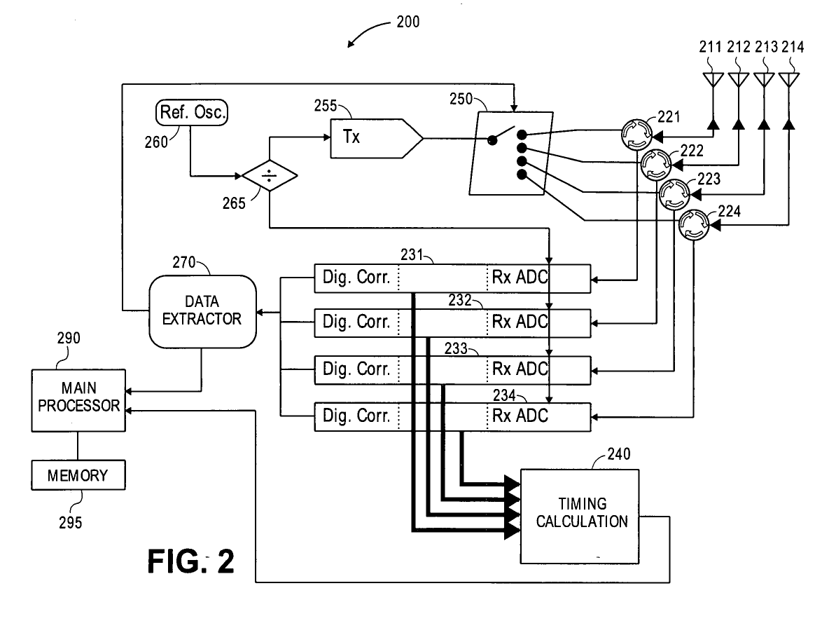

FIG. 2 shows a system for determining a location of an RFID tag, according to an embodiment of the invention. In system 200 a processing circuit, shown in the illustrated embodiment as a main processor 290 and its main memory 295, may be used to perform general purpose processing, including using the calculated location of the RFID tag for useful purposes such as, but not limited to, selective identification of RFID-tagged objects in a known space. In some embodiments main processor 290 and main memory 295 may be part of an RFID reader device, but other embodiments may be configured differently, such as placing one or both of these items external to an RFID reader device.

Reference oscillator 260 may serve as a single time base for both receive and transmit circuitry, thus allowing for synchronized timing between those two functions if needed. A power dividing circuit 265 may be used to split the reference oscillator 260, thus providing a receiver local oscillator source with much of the same distortion characteristics as the transmitter local oscillator source. This may be particularly useful for backscatter modulation RFID systems. In some embodiments all the receive paths may operate from a common clock signal so that their time-critical operations may be synchronized. In the context of this document, a transmit path may contain the circuitry needed to convert a digital data sequence into a modulated radio signal, while each receive path may contain the circuitry needed to demodulate a radio frequency signal into a digital data sequence. In the embodiment shown, each receive path 231-234 may contain, among other things, an analog-to-digital converter (ADC) and a digital correlator. Since the data received from one receive path may be slightly out of sync with the same data received from another receive path, a data extractor 270 may be used to obtain the data from all the receive paths in unambiguous form.

In system 200, transmit path 255 may be selectively coupled to any one of the antennas 211-214 through transmit switch 250 (a multiplexor is also considered a switch in this context), while receive paths 231-234 may each be individually connected to a different one of the antennas. Circulators 221-224 may be used to permit transmit path 255 to transmit through a particular antenna at the same time that the corresponding receive path is receiving through that same antenna. Thus a single, selectable antenna may be used to transmit an enabling signal to an RFID tag in the area, while the response signal from the RFID tag may be received through each antenna separately, with the separate signals being processed separately in the separate receive paths. Since the dynamics of the space in which the RFID tag is located may be unknown, in some embodiments each antenna may sequentially be used for an enabling transmission to determine if a particular transmit antenna produces better quality of response from one or more of the RFID tags being read.

After the received signal has been converted to digital form by the ADC in each receive path, a timing calculation circuit 240 may find a particular point within the digitized waveform signal, compare the relative times of receipt for the same particular point in each of the receive paths, and determine any differences in time of reception for the different receive paths for that same point. Assuming other timing differences have been allowed for, this difference in timing may be due to the different times at which the signal was received by each separate antenna, which in turn may indicate how much nearer or closer each antenna was to the source of the signal (i.e., the RFID tag). Various methods, both known and yet to be discovered, may be used by the timing calculation circuit 240 to determine this timing difference from the received signal in the various receive paths. For additional precision, the digitized waveform may also be interpolated, provided the analog to digital conversion occurs above the Nyquist frequency (or>frequency of interest*2). Because this method may rely on the first instance of waveforms detected, it may be largely immune from multipath interference where indirect reflections are often stronger than the direct reflection.

In some embodiments, the timing calculation circuit 240 merely determines timing parameters, and passes those on to another circuit (e.g., to main processor 290) for determination of location, but other embodiments may use other techniques. Timing calculation circuit 240 may comprise various types of circuits, such as but not limited to a digital signal processor (DSP). In some embodiments this DSP may be separate from the DSP used for other signal processing, but other embodiments may use the same DSP for both purposes, or may even combine the DSP's functionality with that of another processor (e.g., the system processor).

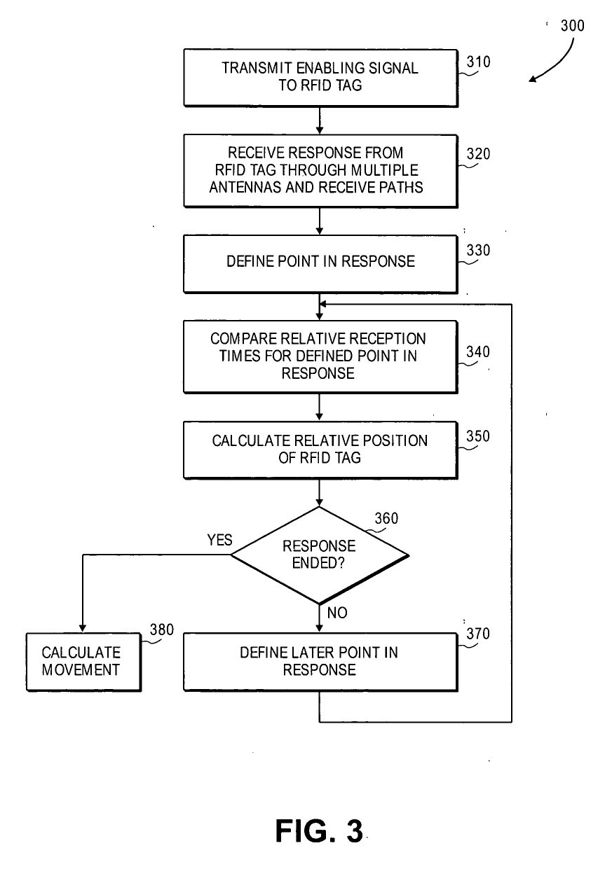

FIG. 3 shows a flow diagram of a method of determining the relative location of an RFID tag, according to an embodiment of the invention. The following process is described in terms of a response from a single RFID tag; however, a similar process may be followed for responses from multiple tags, using currently-known or to-be-developed techniques for handling responses from multiple RFID tags. In flow diagram 300, at 310 an RFID reader may transmit an enabling signal to one or more RFID tags that may be in the vicinity. At 320 the RFID reader may receive a response from an RFID tag that has been enabled by the signal transmitted at 310. The response may be received through multiple antennas, and the signal received through each antenna may be processed through a separate receive path.

At 330 a point may be defined in the received response. This point may be any feasible point, provided it can be resolved to a sufficiently narrow period of time. For example, the point may be the first peak of the sine wave that encodes the first bit of a frequency shift key (FSK) encoded signal, but other points may alternatively be used. In some embodiments this point may be pre-defined by design; while in other embodiments the point may be programmatically selected. At 330, the response in the different receive paths may be processed in a manner that permits determination of the difference in time of receipt of the same defined point in the signals received through the different antennas. Based on 1) these differences in time of receipt, 2) the known relative locations of the antennas, and 3) the propagation speed of the signal, the location of the RFID tag antenna relative to the known locations of the RFID reader antennas may be calculated at 350.

In some embodiments the process may end here, and the location just determined may be used for any feasible purpose. However, since the response from the RFID tag may last many times longer than the time required for operations 340-350, the process may be repeated multiple times within a single response, with the decision block at 360 determining when to stop. In some embodiments the process may be repeated simply to reinforce the reliability of the calculated location, by getting multiple inputs for it. However, in other embodiments movement of the RFID tag during the response time may be tracked by determining a series of locations determined over a period of time. In one such operation, another point that occurs later in the response (as compared to the point determined at 330) may be defined at 370. This may be any feasible point that meets the previously-stated accuracy requirements. For example, the point may be the first peak of the sine wave that encodes the second bit of the frequency shift key (FSK) encoded signal that was described earlier, but other points may alternatively be used. Once this point has been defined, the operations of 340 and 350 may be repeated to determine the location of the RFID tag at this new time. This process may be repeated for successive points in the response until the response ends at 360. At that time, the series of locations may be correlated with the approximate relative time each point in the response was received, and movement (e.g., a motion track and/or speed of movement) for the RFID tag during that time may be calculated at 380. Although the embodiment of the flow diagram shows movement being calculated after the response has ended, other embodiments may calculate movement incrementally as each new location is determined. In still another embodiment, a single location for each response may be calculated, and multiple responses over a period of time may be used to determine subsequent locations and therefore movement.

The location information gained from the described system may be used in various ways. For example, when an RFID reader identifies multiple RFID tags in an area, all tags within a defined space (e.g., a particular pallet of tagged goods) may be inventoried, while the tags in adjacent spaces (e.g., adjacent pallets of tagged goods) may be ignored or separately inventoried. In another example, specific movement of items with RFID tags may be identified and responded to (e.g., when a bin of parts is moved towards an incorrect assembly station).

The foregoing description is intended to be illustrative and not limiting. Variations will occur to those of skill in the art. Those variations are intended to be included in the various embodiments of the invention, which are limited only by the spirit and scope of the following claims.

What is claimed is:

1. An apparatus, comprising:
multiple receive paths, each receive path to be coupled to a corresponding one of multiple antennas to process a signal from a radio frequency identification (RFID) tag as the signal is received through the corresponding antenna;
a timing calculation circuit, coupled to each of the multiple receive paths, to determine differences in the times a particular point in the signal was received at the different antennas; and
a processing circuit to determine a location of the RFID tag relative to the antennas, based on the differences in the times.

2. The apparatus of claim 1, further comprising a transmit path to convert digital information into a signal for transmission.

3. The apparatus of claim 2, further comprising a switch to selectively couple the transmit path to one of the multiple antennas.

4. The apparatus of claim 1, further comprising multiple circulators, each circulator to be coupled between a corresponding receive path, the corresponding antenna, and the transmit path.

5. The apparatus of claim 1, wherein each of the multiple receive paths is coupled to a common clock signal.

6. A system, comprising:
multiple antennas;
multiple receive paths, each receive path coupled to a corresponding one of the multiple antennas to process a signal from a radio frequency identification (RFID) tag as the signal is received through the corresponding antenna;
a timing calculation circuit, coupled to each of the multiple receive paths, to determine differences in the times a particular point in the signal was received at the different antennas; and
a processing circuit to determine a location of the RFID tag relative to the antennas, based on the differences in the times.

7. The system of claim 6, wherein the multiple antennas comprises four antennas, and the multiple receive paths comprises four receive paths.

8. The system of claim 7, wherein the four antennas are arranged to permit a three-dimensional location to be determined.

9. The system of claim 6, wherein the antennas are substantially directional antennas.

10. The system of claim 6, wherein each receive path is coupled to its corresponding antenna and to the transmit path through a corresponding circulator.

11. A method, comprising:
receiving, through multiple antennas, a signal from a radio frequency identification (RFID) tag;
separately processing the signal from each antenna to determine a corresponding first point in each processed signal;
comparing the corresponding first points to determine a relative difference in times of receipt of the corresponding first points; and
determining a first location of the RFID tag, relative to the antennas, based on the relative differences in the times of receipt of the corresponding first points.

12. The method of claim 11, wherein said receiving through multiple antennas comprises receiving through four antennas.

13. The method of claim 12, wherein said determining a location comprises determining a three-dimensional location.

14. The method of claim 11, further comprising:
determining a corresponding second point in each processed signal;
comparing the corresponding second points to determine a relative difference in times of receipt of the corresponding second points;
determining a second location of the RFID tag, relative to the antennas, based on the relative differences in the times of receipt of the corresponding second points.

15. The method of claim 14, further comprising determining a movement of the RFID tag based on differences in the first location and the second location.

16. The method of claim 15, further comprising determining a speed of the movement of the RFID tag based on the differences in the first location and the second location and further based on a relative difference in time between the first point and the second point.
